(19) United States
(12) Patent Application Publication
(10) Pub. No.: US 2010/0116374 A1
(43) Pub. Date: May 13, 2010

(54) METHOD OF ASSEMBLING AN EASY OPEN CONTAINER

(75) Inventors: Alastair Wilson, Wantage (GB); Jason Hall, Buckland (GB); Laure Helene Marie Paillet, Oxford (GB)

Correspondence Address: WOODCOCK WASHBURN LLP, CIRA CENTRE, 12TH FLOOR, 2929 ARCH STREET, PHILADELPHIA, PA, 19104-2891, US

(73) Assignee: CROWN PACKAGING TECHNOLOGY, INC., Alsip, IL (US)

(21) Appl. No.: 12/615,555

(22) Filed: Nov. 10, 2009

Related U.S. Application Data
(60) Provisional application No. 61/113,490, filed on Nov. 11, 2008.

(51) Int. Cl. B67C 3/14; B67C 3/22

(52) U.S. Cl. 141/6; 413/4; 53/486

(57) ABSTRACT

A method of forming a container having enhanced openability is disclosed. The method includes providing a can body, and providing a can end having an approximately planar panel, a pull tab affixed to the panel, and a moveable portion disposed beneath a handle of the tab, the moveable portion being in a first position extending upwardly toward the handle. The method also includes filling a comestible product into the can body at an elevated temperature, seaming the can end to the can body, and moving the moveable portion from the first position to a second position extending downwardly away from the handle, such that a gap is formed or enlarged between the moveable portion and the handle, enhancing accessibility to a user's finger. The moving being in response to internal negative pressure caused by cooling of the product within the can body.

### CROSS REFERENCE TO RELATED APPLICATIONS

This application claims priority to U.S. Provisional Application No. 61/113,490 filed Nov. 11, 2008, the contents of which are incorporated herein by reference in its entirety.

### BACKGROUND

In the field of metal packaging, “easy open” ends for metal cans are well known. Typically, an easy open can end includes a pull tab and an approximately planar panel having a score line defining an opening area. To open a can having an easy open can end, a user may lift a handle of the pull tab to initiate fracture of the score line, and a user may subsequently pull the tab to partially or fully remove a portion of the panel, thereby creating an opening through which a user may access the contents.

Typically, the gap between the pull tab handle and the can end panel is very small. This small gap may make it difficult for a user to grasp the pull tab, because there may not be enough clearance under the pull tab for a user to insert a finger. Therefore, typical easy open cans may be difficult for a user to open.

There is a need for a method of assembling a container including a can end that may allow a user to more easily insert a finger under the pull tab, thereby providing enhanced openability.

### SUMMARY

A method of forming a container having enhanced openability is disclosed. Such a method may include the steps of: (i) providing a can body; (ii) providing a can end having an approximately planar panel, a pull tab affixed to the panel, and a moveable portion disposed beneath a handle of the tab, the moveable portion being in a first position extending upwardly toward the handle; (iii) filling a comestible product into the can body at an elevated temperature; (iv) seaming the can end to the can body; and (v) moving the moveable portion from the first position to a second position extending downwardly away from the handle, such that a gap is formed or enlarged between the moveable portion and the handle, enhancing accessibility to a user's finger, the moving being in response to internal negative pressure caused by cooling of the product within the can body.

These and various other advantages and features are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there are illustrated and described preferred embodiments of the invention.

### BRIEF DESCRIPTION OF THE DRAWINGS

FIG. 1A is a top perspective view of a container including a can end seamed onto a can body;

FIG. 1B is a top perspective view of the can end depicted in FIG. 1A prior to a seaming operation;

FIG. 2A is a side cross-sectional view in the direction of arrows A-A for the can end of FIG. 1B, showing a moveable portion in an up (convex) position;

FIG. 2B is a side cross-sectional view in the direction of arrows A-A for the can end of FIG. 1B, showing a moveable portion in a down (concave) position;

FIG. 2C is a detailed cross-sectional view of the moveable portion and annular step of the can end of FIG. 1B, showing the moveable portion in both up (convex) and down (concave) positions;

FIG. 2D is a side cross-sectional view of the container of FIG. 1A, showing a moveable portion of the can end in an up (convex) position;

FIG. 3A is a schematic illustrating an example hydrostat retort for controlling the temperature and pressure during assembly of a container; and

FIG. 3B is graph showing the temperature and pressure inside and outside of two example containers during assembly in the hydrostat retort illustrated in FIG. 3A.

### BRIEF DESCRIPTION OF THE APPENDICES

Appendix A-1 is a table showing the raw data collected from processing different food products in different types and sizes of containers through different retorts, and determining whether or not the moveable portions 40 toggled to the downward position P2.

Appendix A-2 is a table showing the raw data collected from processing different food products in different types and sizes of containers through different retorts, and determining whether or not the moveable portions 40 toggled to the downward position P2.

### DETAILED DESCRIPTION OF ILLUSTRATIVE EMBODIMENTS

Preferred structures and methods for can end technology are described herein. An embodiment of a can end and can that employ this technology are also described. The present invention is not limited to any particular container configuration but rather encompasses use in any container application. Further, the present invention encompasses other can end designs not described herein.

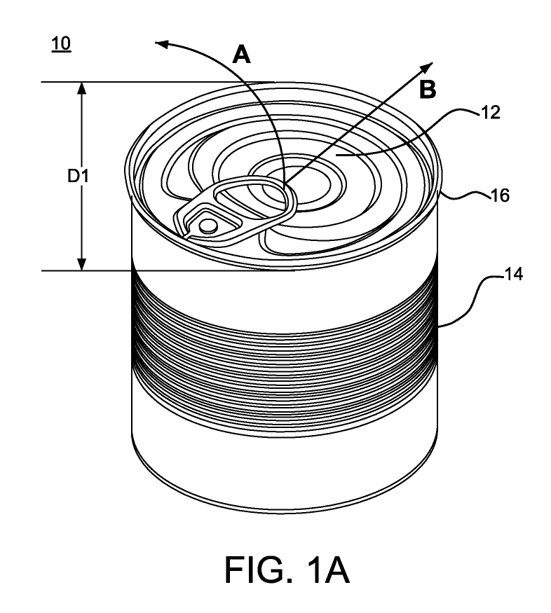

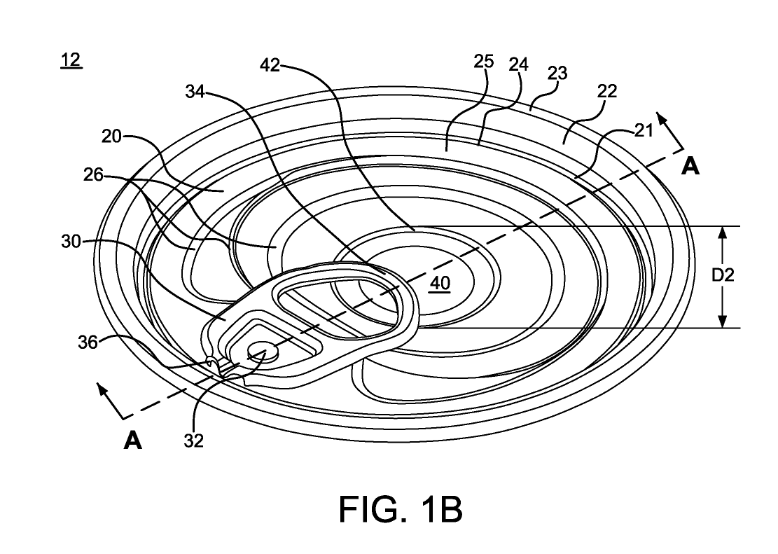

Referring to FIGS. 1A and 1B to illustrate an example structure and function of the present invention, a container 10 includes a can end 12 attached to a can body 14 by a seam 16. The can end 12 defines a diameter D1 and includes an approximately planar panel 20, a countersink 21 extending about the periphery of panel 20, a chuck wall 22 extending radially outward from countersink 21, and a seaming panel 23 extending radially outward from chuck wall 22. As shown, panel 20 includes a score 24, that defines an openable panel portion 25, beading 26, and a moveable portion 40. A tab 30 is attached to panel 20 by rivet 32 proximate to score 24. Tab 30 includes a handle 34, and a nose 36. Moveable portion 40 defines a diameter D2 and optionally includes a downwardly inclined annular step 42.

Container 10 may be made from any material, for example, steel, aluminum, or tin. Container 10 may contain or be configured to contain a comestible product (not shown), including ready meals, fruits, vegetables, fish, dairy, pet food, a beverage, or any other product that it is desirable to have stored in metal packaging such as container 10. Container 10 may have any length, diameter, wall thickness, and volume. Preferably, container 10 has a standard-sized interior volume that is known in the art for containing a comestible product such as ready meals, fruits, vegetables, fish, dairy, pet food, or a beverage.

Can end 12 may be made from any material, for example, steel, aluminum, or tin. Can end 12 preferably is formed from 0.21 mm gauge DR550N double-reduced steel. In the embodiment shown, can end 12 defines a diameter D1 of 73 mm, although in other embodiments (not shown), can end 12 may define a diameter D1 of any size, including, for example, 83 mm and 99 mm. As shown in FIG. 1B, can end 12 includes an approximately planar panel 20 that is formed, pressed, and/or stamped to take a shape that may include several features.

As shown in FIGS. 1A and 1B, countersink 21 is near the periphery of panel 20. As shown, countersink 21 extends upward into chuck wall 22, and chuck wall 22 extends radially outward to form seaming panel 23. Seaming panel 23 is configured to allow can end 12 to be attached to the top of can body 14 via seam 16, which is formed by bending a portion of seaming panel 23 around the top of can body 14. In a preferred embodiment, can end 12 is seamed to can body 14 via seaming means that are known in the art (e.g., double seaming).

When openable panel portion 25 is partially or completely detached from the remainder of panel 20, score 24 and/or openable panel portion 25 define an opening (not shown), through which the comestible product (not shown) may be removed from can body 14. As shown in FIG. 1B, score 24 defines a continuous circle without having a break or gap, thereby allowing openable panel portion 25 to be completely detached from the remainder of panel 20. However, in other embodiments (not shown), score 24 may define a partial loop, such that openable panel portion 25 can only be partially detached from the remainder of panel 20.

As shown in FIG. 1B, openable panel portion 25 extends over most of panel 20, and moveable portion 40 is located within openable panel portion 25. However, in other embodiments (not shown), openable panel portion 25 may extend over a small portion of panel 20 (e.g., openable panel portion 25 may create a small aperture through which a user drinks a beverage), and moveable portion 40 may be located outside of openable panel portion 25.

As shown in FIG. 1B, panel 20 includes one or more beadings 26, which preferably are substantially in the form of downwardly inclined annular or part-annular steps. In FIG. 1B, three beadings 26 are shown, but in other embodiments, any number of beadings 26 may be defined by the shape of panel 20. While not being bound by theory, it is believed that the beading may provide panel 20 with increased strength to resist buckling due to impact to container 10 or a pressure differential across can end 12.

As shown in FIG. 1B pull tab 30 is located on the outer surface of can end 12 and may be coupled to panel 20 by rivet 32. As shown, handle 34 of pull tab 30 is disposed towards the center of panel 20, and nose 36 of pull tab 30 is disposed towards the periphery of panel 20. Tab 30 may be actuated by a user to allow the user to remove some or all of the comestible product (not shown) from can body 14. Tab 30 may be actuated by a user grasping or looping a finger under handle 34 and pulling handle 34 away from panel 20 in the direction of arrow A, thereby rotating tab 30 about rivet 32. As handle 34 moves away from panel 20, nose 32 of tab 30 is forced down towards panel 20, pushing down on panel 20 approximately at or adjacent to score 24, thereby rupturing a first portion of score 24. Subsequently, the user pulls handle 34 in the direction of arrow B, thereby rupturing a second portion of score 24 and defining an opening (not shown) by removing all or part of openable panel portion 25 from the remainder of panel 20.

As shown in FIG. 1B, moveable portion 40 defines a diameter D2 and is defined in panel 20. In the embodiment shown in FIG. 1B, moveable portion 40 is located towards the center of panel 20, and moveable portion 40 is located within openable panel portion 25. However, in other embodiments (not shown), such as beverage container embodiments, moveable portion 40 may be located anywhere on panel 20, including, for example, a location outside openable panel portion 25. In the embodiment shown in FIG. 1B, moveable portion 40 is generally circular in plan. However, in other embodiments (not shown), moveable portion 40 may have other shapes in plan, e.g., an elliptical or an irregular shape.

Moveable portion 40 includes a downwardly inclined annular step 42. As shown in FIG. 1B, annular step 42 is located at the periphery of moveable portion 40. However, in other embodiments (not shown), annular step 42 may be located further towards the center of moveable portion 40, such that the diameter of annular step 42 is less than diameter D2 of moveable portion 40. Annular step 42 preferably is located between the periphery of moveable portion 40 and a location half-way towards the center of moveable portion 40 (i.e., having a diameter of 0.5*D2). In the embodiment shown, annular step 42 defines a diameter ranging between 21.8 mm (inner diameter) and 24.1 mm (outer diameter).

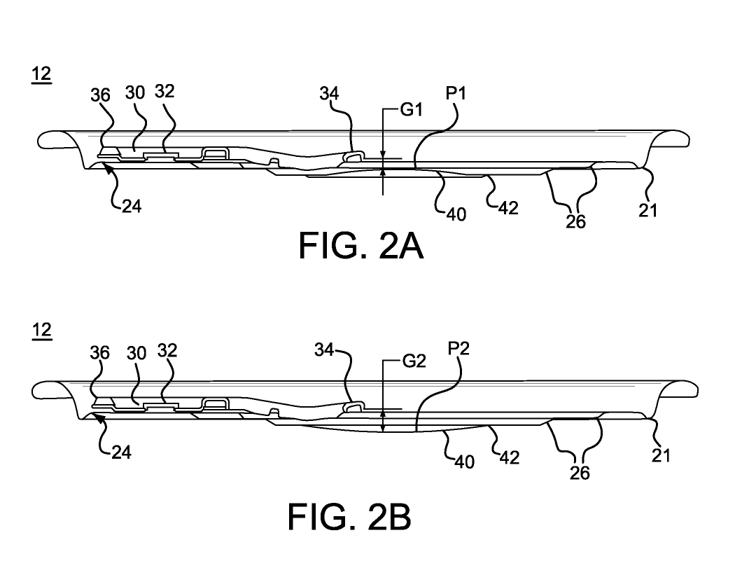

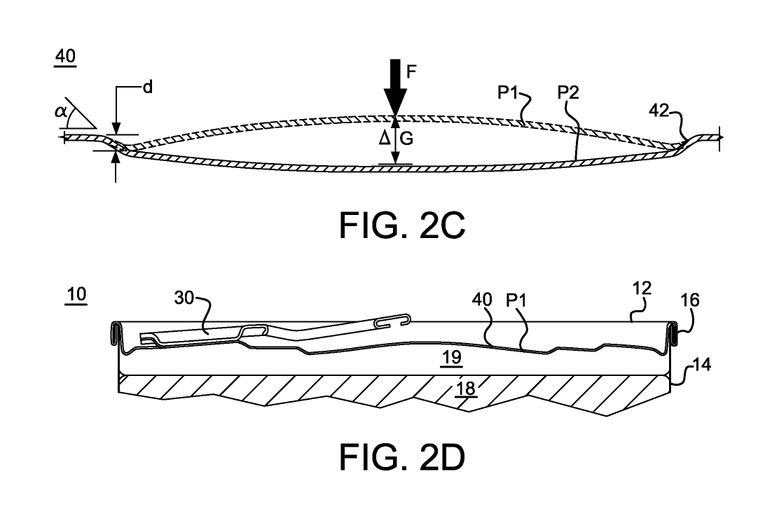

As shown in FIG. 1B, annular step 42 defines a continuous loop without having a break or gap. However, in other embodiments (not shown), annular step 42 may define two or more discontinuous annular step portions, each separated by a gap. As shown in FIG. 1B, moveable portion 40 includes only a single annular step 42. However, in other embodiments (not shown), moveable portion 40 may include any number of annular steps 42. As shown in FIG. 1B, annular step 42 is circular in plan. However, in other embodiments (not shown), annular step 42 may have other shapes in plan, e.g., an elliptical or an irregular shape. Annular step 42 preferably has a linear cross-section (this can be most easily viewed in FIGS. 2A-2C). However, in other embodiments (not shown), annular step 42 may have a curved cross-section.

Referring to FIGS. 2A, 2B, 2C, and 2D, the bottom surface of handle 34 and the upper surface of moveable portion 40 define a first gap G1 when moveable portion 40 is in an up position P1, and the bottom surface of handle 34 and the upper surface of moveable portion 40 define a second gap G2 when moveable portion 40 is in a down position P2. The difference between first gap G1 and second gap G2 is best shown in FIG. 2C as gap difference ΔG. When moveable portion 40 is in the down position, annular step 42 is inclined downward at an angle α to the horizontal, which is preferably between eight and seventeen degrees to the horizontal. In the embodiment shown, angle α is 12.5 degrees to the horizontal. The space between can end 12 and a product 46 (after seaming of can end 12 onto can body 14) is shown in FIG. 2D as a headspace 48.

When moveable portion 40 is in the up position P1, first gap G1 between pull tab handle 34 and moveable portion 40 may be very small, for example, 2 mm. This relatively small first gap G1 may make it difficult for a user to grasp pull tab handle 34, because there may not be enough clearance under the pull tab for a user to insert a finger. When moveable position 40 is in the down position P2, second gap G2 between pull tab handle 34 and moveable portion 40 may be substantially larger than first gap G1. This larger second gap G2 preferably is large enough to make it easy for a user to grasp pull tab handle 34, because there may be enough clearance under pull tab handle 34 for a user to insert at least part of a finger.

Moveable portion 40 preferably has two stable positions (bi-stable), i.e., the up position P1 (shown in FIG. 2A) and the down position P2 (shown in FIG. 2B). When can end 12 is manufactured, moveable portion 40 may be disposed in either the up or down position, depending on the particular forming method chosen. Before seaming can end 12 onto can body 14, moveable portion 40 preferably is disposed in the up position P1, because can ends 12 may be more densely stacked when moveable portion 40 is disposed in the up position. When container 10 is sold to a user, moveable portion 40 is preferably disposed in the down position P2, in order to provide the larger second gap G2 between handle 34 and moveable portion 40 to accommodate a user's finger.

In order to toggle moveable portion 40 from the up position P1 to the down position P2, a force F may be applied, generally in a downward direction, to moveable portion 40 (as shown in FIG. 2C), thereby increasing the size of first gap G1 by a gap difference ΔG to become second gap G2. The force F preferably arises from a pressure differential across can end 12, where the pressure on the upper side of can end 12 (outside the container) is higher than the pressure on the lower side of can end 12 (inside the container). In other embodiments, the force F may arise from a mechanical force applied to the upper side of the moveable portion 40. Under some processing conditions, the force F may be a pressure differential across can end 12 for a first set of containers 10 in a processing batch, while the force F may be a mechanical force applied to the upper side of moveable portion 40 for a second set of the containers 10 in the processing batch (e.g., those containers 10 that still have a moveable portion 40 in the up position P1 after initial processing).

In some embodiments, it is desirable that can ends 12 be transported to the product-filling facility with moveable portion 40 in the up position P1. While can ends 12 may be formed with moveable portion 40 in either the up position P2 or the down position P2, can ends 12 may be more easily stacked for transportation with moveable portions 40 in the up position P1. For example, in the embodiment shown in FIG. 2D, during stacking of the can ends 12, the tab 30 of a lower can end 12 (with the moveable portion 40 in the up position P1) may nest into the bottom surface of the moveable portion 40 (in the up position P1) of an upper can end. In some embodiments, it may be necessary for moveable portions 40 to be disposed in the up position P1 to prevent damage to tabs 30 during processing, such as when using a reel and spiral retort.

As shown in TABLE 1 (page 8), the presence of annular step 42 in moveable portion 40 may allow moveable portion 40 to stay in the “down” position under a greater variety of post-filling pressure conditions than if annular step 42 was not included. To produce the data shown in TABLE 1, tests were performed using can end 12 designs (with and without annular step 42) having a diameter D1 of 73 mm. Each can end 12 was made of 0.21 mm gauge, double-reduced (DR) tinplate to material specification DR550N. As shown, the presence of annular step 42 may allow container 10 to better withstand impacts and/or high-altitude transportation (at lower ambient pressure) without moveable portion 40 toggling back into the up position P1. If containers 10 are shipped to a high-altitude location, for example, the lower atmospheric pressure may lower the pressure differential across can ends 12, increasing the chance that moveable portions 40 may toggle back into the up position P1. While not being bound by theory, the presence of annular step 42 may increase the pressure differential across the can end 12 that is required to toggle moveable portion 40 back into the up position P1.

TABLE 1

| Moveable Portion | Pressure differential to | Pressure differential to |
|---|---|---|
| Type | “Pop-down” (mbar) | “Pop-up” (mbar) |
| No Annular Step | >1000 | 350 |
| Annular Step | 830 | 790 |

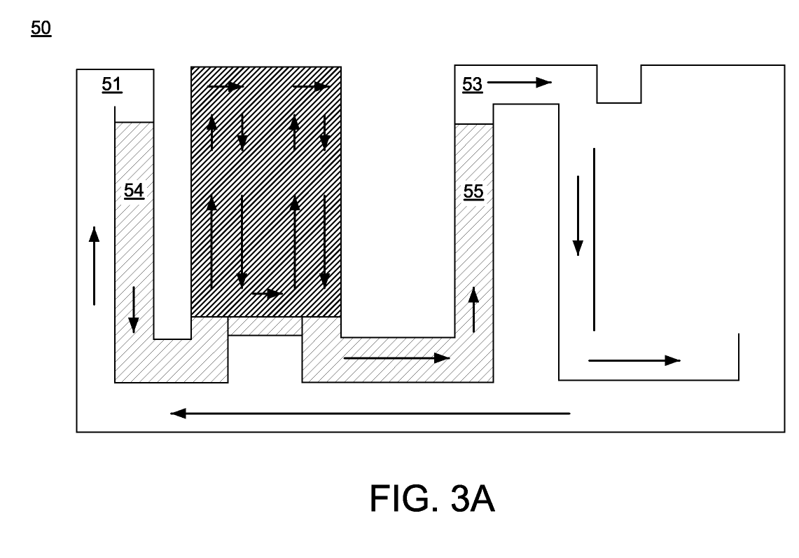

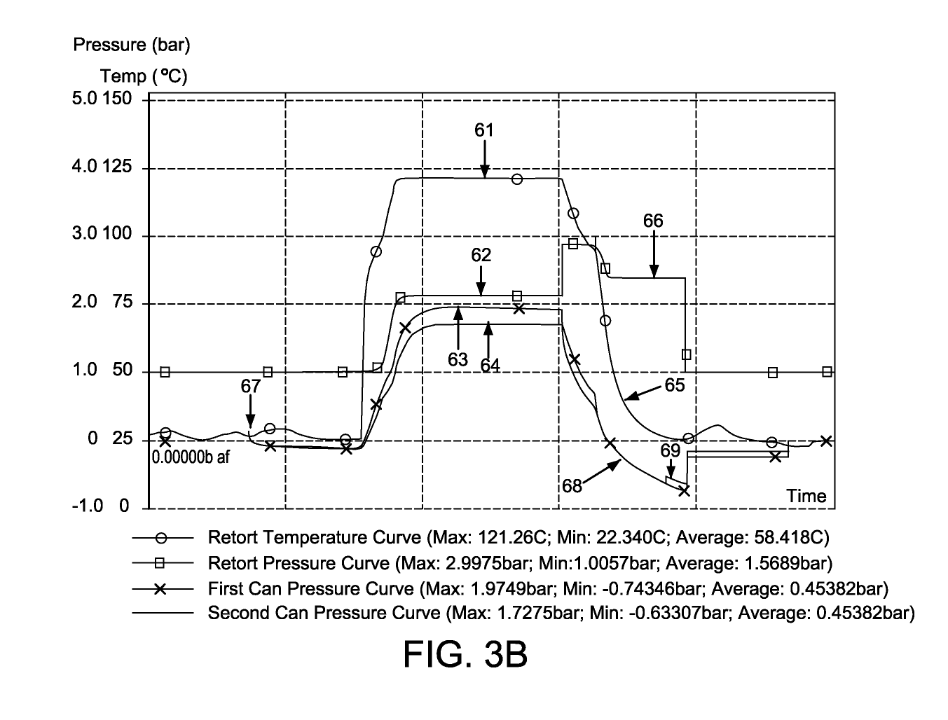

FIG. 3A is an example of a hydrostat retort that may be used to control the temperature and pressure during assembly of the container of FIG. 1A. Referring to FIG. 3A, a hydrostat retort system 50 includes a preheat leg 51, a steam leg 52, and a cooling leg 53. Preheat leg 51 includes a first water column 54. Cooling leg 53 includes a second water column 55. As shown in FIG. 3A, hydrostat retort system 50 may be used to control the temperature and pressure of container 10 during the filling process. However, in other embodiments, any retort system may be used, including a batch retort, a reel and spiral retort, and a hydrolock retort.

FIG. 3B is a graph showing temperature and pressure inside and outside two example containers of during assembly in the hydrostat retort of FIG. 3A. Referring to FIG. 3B, the temperature and pressure graph includes a retort temperature curve 61, a retort pressure curve 62, a first can pressure curve 63, and a second can pressure curve 64. The retort temperature curve 61 includes a cool-down period 65. The retort pressure curve 62 includes an over-pressure period 66. The first can pressure curve 63 and the second can pressure curve 64 include a seaming time 67 (during which the containers 10 are seamed) and a low-pressure period 68. The second can pressure curve 64 includes a pressure jump 69.

As shown in FIG. 3B, the temperature and pressure graph shows data for two containers 10 (a first can and a second can), each filled with product 46 having different process parameters, such as different amounts of headspace 48 and different product temperatures.

The retort temperature curve 61 shows the retort starting out at ambient temperature (for example, 25° C.), increasing and being held at a high temperature (which may kill any bacteria in the product 46), and then entering a cool-down period 65, during which the retort drops back down to the ambient temperature. The retort pressure curve 62 shows the retort starting at ambient pressure, increasing and being held at a high pressure (which may allow the product 46 to be heated to a higher temperature without the included water boiling), and then entering an over-pressure period, after which the retort drops back down to the ambient pressure.

The first can pressure curve 63 shows the output of a pressure sensor placed inside of a first container 10. The first can pressure 63 shows the can pressure starting out at ambient pressure (for example, atmospheric pressure), the pressure dropping slightly after the seaming time 67, the pressure increasing while the retort pressure curve 62 is increasing, and the pressure dropping during a low-pressure period 68 that coincides with the cool-down period 65 and the over-pressure period 66.

The second can pressure curve 64 shows the output of a pressure sensor placed inside of a second container 10. The second can pressure 64 shows the can pressure starting out at ambient pressure, the pressure dropping slightly after the seaming time 67, the pressure increasing while the retort pressure curve 62 is increasing (to a lower maximum pressure than the first can pressure curve 63, which may be due to a different amount of headspace 48 or a different initial product 46 temperature), and the pressure dropping during a low-pressure period 68 that coincides with the cool-down period 65 and the over-pressure period 66. The second can pressure curve 64 includes a pressure jump 69, which represents the point where moveable portion 40 toggles from the up position P1 (shown in FIG. 2A) to the down position P2 (shown in FIG. 2B), momentarily slightly increasing the pressure in the second container 10.

As shown in FIG. 3B, the low-pressure period 68 of the first can pressure curve 63 and the second can pressure curve 64 may create a pressure differential across can ends 12 that results in a force F acting downward on moveable portion 40 (as shown in FIG. 2C). The low-pressure period 68 is created by the cooling of the steam that has collected in the headspace 48. If the pressure differential across can ends 12 is high enough, for example, 500 or 800 mbar, then the force F acting downward on moveable portion 40 may be sufficient to toggle moveable portion 40 from the up position P1 to the down position P2, thereby allowing increased finger access under tab 30 for a user.

Before container 10 is seamed at the seaming time 67, a hot product 46 (at an initial equilibrium temperature, for example, of 50-70° C., that is higher than the ambient temperature), which may include a food product and juice or water, is inserted into can body 14. At the seaming time 67, can end 12 is seamed onto can body 14, trapping the hot product 46 (that may contain some steam) into container 10. If the hot product 46 is not sufficiently hot (at an initial equilibrium temperature, for example, of 25-35° C.) to result in a high enough force F acting downward on moveable portion 40 during the cool-down period 65, steam flow closing may be used during the seaming of container 10 to allow sufficient steam to be trapped into container 10 at the seaming time 67.

During the cool-down period 65, container 10 is cooled down, gradually approaching ambient temperature. During the cool-down period 65, the steam that was trapped inside container 10 at the seaming time 67 may be at a lower temperature than the initial temperature at seaming of container 10. This lower temperature and resulting condensation of the steam trapped inside container 10 may result in the low-pressure period 68 being below the initial pressure inside container 10 at the seaming time 67.

In some embodiments, the presence of an over-pressure period 66 may not be required to produce a sufficient pressure differential across can ends 12 to toggle moveable portion 40 to the down position P2. During the cool-down period 65, the steam that may be present in headspace 48 may condense, which may reduce the pressure inside of container 10, as shown in FIG. 3B. This reduced pressure inside of container 10 may produce a downward force F acting on moveable portion 40, as long as the pressure inside container 10 is less than the pressure outside of container 10. In some embodiments, this lower internal pressure inside container 10 due to the condensation of the steam in headspace 48 may be sufficient to toggle moveable portion 40 into the down position P2.

In some embodiments, during the low-pressure period 68, the combination of the temperature drop during the cool-down period 65 and the high retort pressure during the over-pressure period 66 may both contribute to creating a pressure differential across can ends 12 that results in a force F acting downward on moveable portion 40. In such embodiments, it may be beneficial for toggling of moveable portion 40 to have a over-pressure period 66 during the cool-down period 65. The amount of external pressure in the retort may be correlated to whether or not moveable portion 40 toggles to the down position P2 during cool-down. For example, as shown in FIG. 3B, the retort pressure reaches a maximum pressure of approximately 3000 mbar, which may contribute to the force F acting downward on moveable portion 40, combining with the reduction of pressure inside container 10 that also may contribute to the force F acting downward on moveable portion 40. If the combination of over-pressure in the retort and partial vacuum inside of container 10 produces a high enough force F acting downward on moveable portion 40, moveable portion 40 may toggle into the desired downward position P2 during processing.

As shown in TABLE 2, data has suggested that when processing a batch of containers 10 of a design that does not include the optional annular step 42, a pressure differential across the can end 12 of at least 500 mbar may result in 100% of the containers 10 having their moveable portions 40 toggled to the down position P2. Data has suggested that when processing a batch of containers 10 of a design that include an annular step 42, a pressure differential across the can end 12 of at least 800 mbar may result in 100% of the containers 10 having their moveable portions 40 toggled to the down position P2. However, as will be discussed below, there are several process variables that may contribute to whether or not a particular set of containers 10 complete processing with their moveable portions 40 toggled to the down position P2, including, but not limited to, the diameter D1 of the can end 12, the type of product 46 contained in container 10, the temperature of product 46 contained in container 10, the length of time during which container 10 is cooled, the external pressure in the retort acting on the outside of can end 12, and headspace 48 (shown in FIG. 2D) between product 46 and can end 12 during processing. The effect of several process variables on whether or not moveable portion 40 toggles to the down position P2 may be gleaned from a careful analysis of the data shown in Appendices A-1 and A-2.

TABLE 2

| Moveable Portion | Can End | Pressure differential to |
|---|---|---|
| Type | Diameter | “Pop-down” (mbar) |
| No Annular Step | 73 mm | >500 |
| Annular Step | 73 mm | >800 |

As shown in TABLE 3, data has suggested that the diameter D1 of can end 12 may be correlated to whether or not moveable portion 40 toggles down to the down position P2 during cool-down following seaming and processing in a retort. TABLE 3 shows data of approximate pressure differentials across can end 12 during hydrostat retort processing that have resulted in enough downward force acting on moveable portion 40 to toggle moveable portion 40 to the down position P2. While not being bound by theory, it is believed that it may take a higher force to toggle moveable portion 40 in the particular designs of can end 12 that have a larger diameter D1, such as 99 mm, compared to a smaller force required to toggle moveable portion 40 to the down position in the designs of can end 12 that have a smaller diameter D1, such as 73 mm.

TABLE 3

| Can End | Pressure differential to |
|---|---|
| Diameter | “Pop-down” (mbar) |
| 73 mm | >300 |
| 83 mm | >600 |
| 99 mm | >1000 |

The degree of cooling while containers 10 are in the over-pressure state in a retort may also be correlated to whether or not moveable portion 40 toggles to the down position P2 during cool-down. While not being bound by theory, it is believed that containers 10 having a can end 12 with a larger diameter D1, such as 99 mm, may retain more heat for a longer period of time than containers 10 having a can end 12 with a smaller diameter D1, such as 73 mm. Therefore, in some designs of can ends 12 having larger diameters D1, the larger diameter containers 10 may not reach a temperature that is close enough to ambient temperature (prior to removal of the over-pressure) to allow enough condensation of steam in the headspace 48 to create a sufficient pressure differential across the can end 12 to toggle moveable portion 40 to the down position P2. For example, if the temperature in container 10 remains relatively high (e.g., 40° C.) before the over-pressure is removed, then there may not be a low enough pressure inside container 10 to toggle the moveable portion. In some embodiments, even if container 10 continues to cool down towards ambient temperature after the over-pressure is removed, the partial vacuum might not be great enough (without the over-pressure) to toggle moveable portion 40 to the down position.

The type of product 46 contained in container 10 and the temperature of the product and juice included in the product 46 may affect whether or not there will be sufficient force during processing to toggle moveable portion 40 from the up position P1 to the down position P2. While not being bound by theory, it is believed that a juice temperature of at least 70° C. may allow sufficient steam to become trapped in container 10 at the time of seaming to allow a sufficient vacuum to develop inside container 10 after container 10 begins to approach ambient temperature (for example, 25° C.). A partial vacuum (i.e., less than atmospheric pressure inside of container 10) may develop in container 10 due to cooling of the steam that was trapped in container 10 at the time of seaming. When the steam at least partially condenses, it takes up less room in container 10 and may create a partial vacuum.

The amount of headspace 48 contained in container 10 between product 46 and can end 12 may affect whether or not there will be sufficient force during processing to toggle moveable portion 40 from the up position P1 to the down position P2. While not being bound by theory, it is believed that a headspace of approximately 5-10 mm may be sufficient to allow moveable portion 40 to toggle to the down position P2 (see Appendices A-1 and A-2 for detailed headspace data and corresponding results). If headspace 48 contained in container 10 at the time of seaming is higher, this may allow a greater amount of steam to be trapped inside container 10 at the time of seaming, which may result in a lower pressure inside container 10 after cooling and condensation of the steam inside container 10. This lower pressure inside container 10 may increase the likelihood that moveable portion 40 will toggle to the down position P2.

In some embodiments, a portion of containers 10 may complete retort processing with moveable portions 40 in the up position P1. In such embodiments, it may be desirable to add a mechanical push-down processing step to mechanically toggle moveable portions 40 that are still in the up position P1 so that moveable portions 40 can be shipped to consumers in the down position P2. For example, in one embodiment, there is a post-retort panel pusher comprising a driven wheel mounted over a slat conveyor (the wheel is driven to match the conveyor speed) that is arranged to push moveable panels 40 down as containers 10 pass under the wheel.

The foregoing description is provided for the purpose of explanation and is not to be construed as limiting the invention. While the invention has been described with reference to preferred embodiments or preferred methods, it is understood that the words which have been used herein are words of description and illustration, rather than words of limitation. Furthermore, although the invention has been described herein with reference to particular structure, methods, and embodiments, the invention is not intended to be limited to the particulars disclosed herein, as the invention extends to all structures, methods and uses that are within the scope of the appended claims. Those skilled in the relevant art, having the benefit of the teachings of this specification, may effect numerous modifications to the invention as described herein, and changes can be made without departing from the scope and spirit of the invention as defined by the appended claims. Furthermore, any features of one described embodiment can be applicable to the other embodiments described herein.

What is claimed:

1. A method of forming a can having enhanced openability, the method comprising:
providing a can body;
providing a can end having a panel, a pull tab affixed to the panel, and a moveable portion disposed beneath a handle of the pull tab, the moveable portion being in a first position extending upwardly toward the handle;
filling a comestible product into the can body at an elevated temperature;
seaming the can end to the can body; and
moving the moveable portion from the first position to a second position extending downwardly away from the handle, such that a gap is formed or enlarged between the moveable portion and the handle, the moving being in response to internal negative pressure caused by cooling of the product within the can body.

2. The method of claim 1, wherein the elevated temperature is at least 50° C.

3. The method of claim 1, wherein the elevated temperature is at least 70° C.

4. The method of claim 3, further comprising placing steam inside the can body prior to seaming.

5. The method of claim 1, wherein a pressure inside the can is at least 500 mbar less than an ambient pressure outside the can.

6. The method of claim 1, wherein a pressure inside the can is at least 800 mbar less than an ambient pressure outside the can.

7. The method of claim 1, wherein the filling step results in a headspace of at least 5 mm.

8. The method of claim 7, wherein the seaming step includes forming a double seam.

9. The method of claim 1, wherein the panel includes a score about its periphery for enabling opening.

10. The method of claim 9, wherein a nose of the pull tab is disposed above a portion of the score, the pull tab being configured to open the can at the portion of the score when the handle is pulled by a user's finger.

11. The method of claim 1, wherein the moveable portion includes a downwardly inclined annular step.

12. The method of claim 11, wherein the downwardly inclined annular step is inclined downwardly at between 8 and 17 degrees.

13. The method of claim 11, wherein the downwardly inclined annular step includes a drop of between 0.007 and 0.013 inches.

14. The method of claim 11, wherein the downwardly inclined annular step is located half-way between the periphery of the moveable portion and the center of the moveable portion.

15. A method of forming a can having enhanced openability, comprising:
providing a can body;
providing a can end having a panel, a pull tab affixed to the panel, and a moveable portion disposed beneath a handle of the tab, the moveable portion being in a first position extending upwardly toward the handle;
filling a comestible product including a juice into the can body, the juice being at a first temperature;
seaming the can end to the can body to create the can;
creating an over-pressure condition around the can;
cooling the can to a second temperature that is lower than the first temperature; and
moving the moveable portion from the first position to a second position extending downwardly away from the handle, such that a gap is formed or enlarged between the moveable portion and the handle, the moving being in response to a pressure differential across the can end.

16. The method of claim 15, wherein the first temperature is at least 50° C.

17. The method of claim 15, wherein the first temperature is at least 70° C.

18. The method of claim 17, further comprising placing steam inside the can body prior to seaming.

19. The method of claim 15, wherein the second temperature is at most 53° C.

20. The method of claim 15, wherein a pressure inside the can is at least 500 mbar less than an ambient pressure outside the can.

21. The method of claim 15, wherein the over-pressure condition around the can is at least 1000 mbar greater than an ambient pressure.

22. The method of claim 15, wherein the over-pressure condition around the can is at least 1000 mbar greater than a pressure inside the can.

23. The method of claim 15, wherein the filling step results in a headspace of at least 5 mm.

24. A method of forming a can having enhanced openability, comprising:
providing a can body;
providing a can end having a panel, a pull tab affixed to the panel, and a moveable portion disposed beneath a handle of the tab, the moveable portion being in a first position extending upwardly toward the handle;
filling a comestible product including a juice into the can body, the juice being at a first temperature;
seaming the can end to the can body to create the can;
heating the can to a second temperature that is higher than the first temperature;
cooling the can to a third temperature that is lower than the first temperature; and
moving the moveable portion from the first position to a second position extending downwardly away from the handle, such that a gap is formed or enlarged between the moveable portion and the handle, the moving being in response to a pressure differential across the can end.

25. The method of claim 24, wherein the first temperature is at least 70° C.

26. The method of claim 24, wherein the first temperature is less than 70° C.

27. The method of claim 26, further comprising placing steam inside the can body prior to seaming.

28. The method of claim 24, wherein the third temperature is at most 53° C.

29. The method of claim 24, wherein a pressure inside the can is at least 500 mbar less than an ambient pressure outside the can.

30. The method of claim 24, wherein the filling step results in a headspace of at least 5 mm.
